(19) United States
(12) Patent Application Publication
(10) Pub. No.: US 2010/0079612 A1
(43) Pub. Date: Apr. 1, 2010

(54) Method and apparatus for processing images acquired by camera mounted in vehicle

(75) Inventor: Takayuki Kimura, Kariya-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/586,204

(22) Filed: Sep. 18, 2009

(30) Foreign Application Priority Data
Sep. 19, 2008 (JP) 2008-240929

(51) Int. Cl. H04N 5/228

(52) U.S. Cl. 348/222.1; 348/E05.031

(57) ABSTRACT

An apparatus processes an image acquired by a single camera mounted in a vehicle, the image imaging a field of view on and along a road on which the vehicle runs. In the apparatus, from the acquired image, a region indicative of a target vehicle is extracted. Based on an illuminance of the image around the target vehicle in the image, a correction region is calculated whose illuminance should be corrected. The correction region includes both the region indicative of the target vehicle and a vicinity of the region. A region of halation being predicted in the calculated correction region is calculated. The illuminance of the region of halation being predicted is corrected so that no or less halation is caused in the region of the halation being predicted. An image in which the corrected region of halation is overlapped on the acquired image is outputted.

### CROSS REFERENCE TO RELATED APPLICATION

This application is based on and claims the benefit of priority from earlier Japanese Patent Application No. 2008-240929 filed on Sep. 19, 2008, the description of which is incorporated herein by reference.

### BACKGROUND OF THE INVENTION

1. Field of the Invention

The present invention relates to a method and an apparatus for processing images acquired by a camera mounted in a vehicle, and in particular, to the method and the apparatus suitably adapted to processing for images undergoing halation caused in a condition where, for example, light around the vehicle is lower at night.

2. Technical Background

In recent years, vehicles are often provided with various types of image processing apparatuses. As one of such image processing apparatuses, there has been known an apparatus taught by Japanese Patent Laid-open Publication No. 2006-325135. This conventional image processing apparatus, which is composed of a single imaging apparatus, is used for identifying white lines drawn on the road or for visualizing views ahead of a vehicle at night. This apparatus has sensitivity in both the waveband of infrared light and the waveband of visible light, and adapted to acquire images of both wavebands and process the acquired images for identifying the white lines and viewing at light.

Since this conventional image processing apparatus is composed of a single apparatus, there is no need to mount in a vehicle a plurality of type of imaging apparatuses whose imaging sensitivities are directed to mutually different light wavebands. Thus it is possible to reduce a mounting space of the vehicle in which the apparatus is mounted.

However, in the conventional image processing apparatus composed of the single apparatus, there is a problem that wavelength characteristics needed for various types of objects being imaged are different from each other. Hence, the apparatus suffers from unifying sensing characteristics of both a sensor (camera) suited for acquiring images having low illuminance that includes that from the background and a sensor (camera) suited for acquiring images having high illuminance that includes that from the white lines on the roads. Practically, when the unification is made by using, as a standard, the sensing characteristic of the sensor for acquiring images having lower illuminance levels, incidence of visible light components will disappear because the visible light components are cut for avoiding the halation. This reduces the imaging sensitivity, thereby deteriorating the imaging performance. In contrast, the unification made by using, as a standard, the sensing characteristic of the sensor for acquiring images having higher illuminance levels excludes the use of a filter for cutting the visible light. Hence, in this case, the acquired images suffer from halation due to reflection of visible light components of the headlights, heavily deteriorating the imaging performance.

### SUMMARY OF THE INVENTION

The present invention has been made to overcome such a problem, and it is therefore an object of the present invention to provide an apparatus having a single sensor (camera) and a method using a single sensor (camera), which are still able to image objects with no or less halation even if the objects provide higher illuminance in dark environments such as nighttime.

In order to achieve the above object, as one mode, the present invention provides an apparatus for processing an image acquired by single image acquisition means mounted in a vehicle, the image acquisition means imaging a field of view on and along a road on which the vehicle runs. The apparatus comprises vehicle-region extracting means for extracting from the acquired image a region indicative of a target vehicle (i.e., oncoming vehicle or passing vehicle) captured by the image acquisition means; correction-region calculating means for calculating a correction region whose illuminance should be corrected, based on an illuminance of the image around the target vehicle in the image, the correction region including both the region indicative of the target vehicle and a vicinity of the region indicative of the target vehicle; halation-region calculating means for calculating a region of halation being predicted in the calculated correction region, the region of halation being predicted due to having an illuminance level at which the halation is caused; correction means for correcting the illuminance of the region of halation being predicted so that no or less halation is caused in the region of the halation being predicted; and image output means for outputting an image in which the corrected region of halation whose illuminance is corrected is overlapped on the image acquired by the image acquisition means.

As another mode, the present invention provides a method of processing an image acquired by single image acquisition means mounted in a vehicle, the image acquisition means imaging a field of view on and along a road on which the vehicle runs, the method comprising steps of: extracting from the acquired image a region indicative of a target vehicle captured by the image acquisition means; calculating a correction region whose illuminance should be corrected, based on an illuminance of the image around the target vehicle in the image, the correction region including both the region indicative of the target vehicle and a vicinity of the region indicative of the target vehicle; calculating a region of halation being predicted in the calculated correction region, the region of halation being predicted due to having an illuminance at which the halation is caused; correction means for correcting the illuminance of the region of halation being predicted so that no or less halation is caused in the region of the halation being predicted; and image output means for outputting an image in which the corrected region of halation whose illuminance is corrected is overlapped on the image acquired by the image acquisition means.

Still, as another mode, the present invention provides an imaging apparatus to be mounted in a vehicle, comprising: single image acquisition means to be mounted in the vehicle to image a field of view on and along a road on which the vehicle runs; vehicle-region extracting means for extracting from the acquired image a region indicative of a target vehicle captured by the image acquisition means; correction-region calculating means for calculating a correction region whose illuminance should be corrected, based on an illuminance of the image around the target vehicle in the image, the correction region including both the region indicative of the target vehicle and a vicinity of the region indicative of the target vehicle; halation-region calculating means for calculating a region of halation being predicted in the calculated correction region, the region of halation being predicted due to having an illuminance at which the halation is caused; correction means for correcting the illuminance of the region of halation being predicted so that no or less halation is caused in the region of the halation being predicted; and image output means for outputting an image in which the corrected region of halation whose illuminance is corrected is overlapped on the image acquired by the image acquisition means.

Hence, even if the apparatus has a single sensor (camera) and the method uses a single sensor (camera), the illuminance of the region of halation being predicted is corrected so that no or less halation is there. Therefore, it is able to image objects with no or less halation even if the objects provide higher illuminance in dark environments such as nighttime. In the present invention, the term “the target vehicle and the vicinity thereof” refers to both a region occupied by the target vehicle in the image, which is extracted by the vehicle extracting means, and a region to be influenced by light sources located in the region occupied by the target vehicle. Specifically, the term “the vicinity thereof” includes road reflections of headlights of the target vehicle and light expansion caused by a blur generated by a feature (such as aberration) of the image acquisition means.

Further, the “illuminance to cause halation” refers to illuminance levels that cause blur in an Image acquired by the image acquisition means, which is caused by high illuminance of an object (such as a target vehicle). This illuminance varies depending on an individual characteristic, such as a saturation characteristic, of the image acquisition means.

### BRIEF DESCRIPTION OF THE DRAWINGS

In the accompanying drawings:

FIG. 1 is a block diagram showing a schematic construction of an imaging apparatus to which the present invention is applied;

FIG. 2 is a flowchart showing a flow of an image correction process;

FIG. 3 is an exemplified drawing showing contents of a correction region calculating process; and

FIGS. 4A and 4B exemplify contents of a halation region calculation process and an image correction process.

### DETAILED DESCRIPTION OF PREFERRED EMBODIMENT

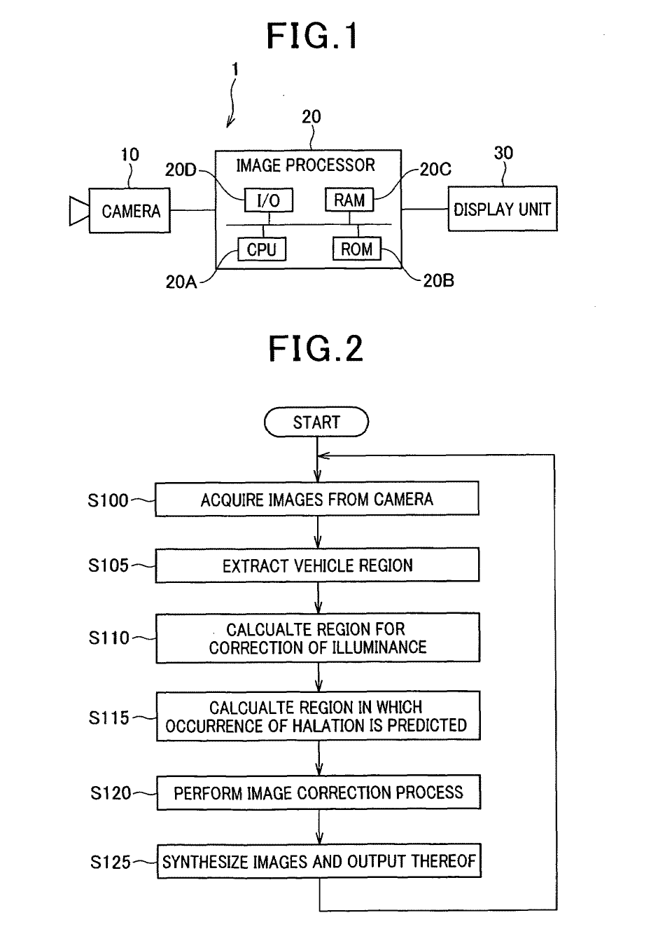

Referring to FIGS. 1 to 4, a preferred embodiment to which the present invention is applied will now be described.

FIG. 1 is a block diagram showing a schematic construction of an imaging apparatus 1 to which the present invention is applied. As shown in FIG. 1, the imaging apparatus 1 comprises a single camera 10 serving as image acquisition means, an image processor 20 serving as an image processing apparatus according to the present invention, and a display unit 30. Image output signals outputted from the image processor 20 are displayed by the display unit 30.

The camera 10 is mounted in a vehicle to acquire images of a field of view on and along a road along which the vehicle runs. The camera 10 employed in this preferred embodiment is attached to the backside of a room mirror disposed at a front upper portion of the interior of the vehicle so as to acquire images ahead of the vehicle.

The camera 10 is a night vision camera which is able to acquire images at night. The night vision camera is an infrared camera or a high sensitive camera whose wavelength characteristic is expanded to an infrared region by excluding a filter that is used for cutting the infrared region in a regular visible-light camera.

The image processor 20 is provided with a CPU (central processing unit) 20A, a ROM (read-only memory) 20B, a RAM (random access memory) 20C, an I/O (input/output) interface 20D, and other components (not shown) necessary for enabling the image processor 20 to work as a computer system. In accordance with an image process program stored in the ROM 20B, the CPU 20 cooperates with the other components to perform a vehicle extracting process, a correction region calculating process, a halation region calculating process, an image correction process, and an image output process. The vehicle extracting process is adapted to extract a target vehicle out of an image acquired by the camera 10. In this case, the target vehicle is an oncoming vehicle which runs toward the vehicle in which the imaging apparatus and the image processing apparatus according to the present invention are mounted. Such an oncoming vehicle becomes a target for the process according to the present invention, so that the oncoming vehicle is referred to as a “target vehicle” in the following.

The correction region calculating process is adapted to calculate a region of which illuminance (luminance, lightness, or intensity of illuminance), should be corrected based on the illuminance of the acquired image. Hereinafter this region is referred to as a “correction region.” The correction region includes the region indicative of a target vehicle and the vicinity of the target vehicle region in the image acquired by the camera 10.

The halation region calculating process, which is performed by the image processor 20 at intervals, is adapted to calculate a region which has illuminance levels which cause the halation. Hence, this process gives a prediction that there will definitely be caused halation in the correction region calculated by the correction region calculating process. Hereinafter the region calculated by the halation region calculating process is referred to as a “halation-predicted region.”

Further, the image correction process, which is performed by the image processor 20, is adapted to correct the illuminance of the halation-predicted region to its illuminance levels which will not cause the halation.

The image output process is adapted to overlap the halation-predicted region corrected by the correction process on the images acquired by the camera 10, and output the overlapped images to the display unit 30.

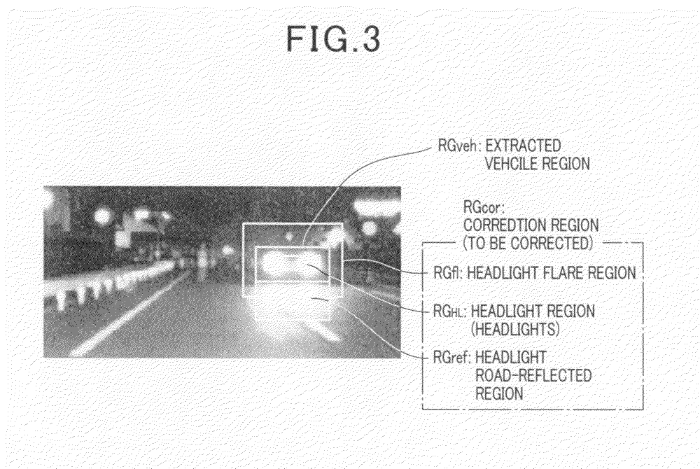

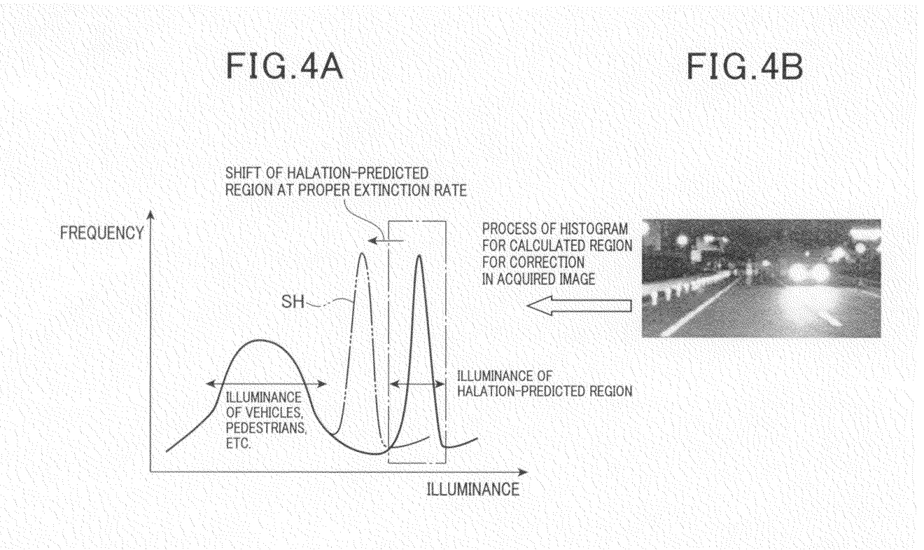

The image correction process performed by the image processor 20 (i.e., by the CPU 20A) will now be detailed with reference to FIGS. 2 to 4. FIG. 2 is a flowchart showing the flow of the image correction process and FIG. 3 is an example showing the contents of the correction region calculating process performed at intervals. FIGS. 4A and 4B show the contents of the halation region calculating process and the image correction process.

First, at step S100 in FIG. 2, the image process allows the camera 10 to acquire image signals at intervals. An example of the image acquired by the camera 10 is shown in FIG. 3.

At a succeeding step S105, the image process is performed to extract a target vehicle from the image acquired at the step S100. This image process to extract the target vehicle from the acquired image is well-known. For example, a technique taught by Japanese Patent Laid-open publication No. 2007-290570 can be used, where the acquired image is compared with various types of image data of reference vehicles previously stored as references in the ROM 20B. If the comparison provides pixels whose intensities correspond to one of the image data of the reference vehicles or fall within a predetermined range of differences from one of the image data of the reference vehicles, it is determined that there is a target vehicle in the acquired image and the target vehicle is shown by such pixels. Hence data showing the target vehicle is extracted from the acquired image. An extraction result of the target vehicle is shown in FIG. 3.

At a succeeding step S110, the acquired image is subjected to calculation with which a correction region having illuminance to be corrected is calculated. As shown in FIG. 3, the correction region includes i) a region of the headlights of the target vehicle (referred to as a “headlight region RG_{HL}”) of the vehicle which is extracted at step S105, ii) a region in which the light from the headlights are reflected on the road (referred to as a “headlight road-reflected region RG_{ref}”), and iii) a portion of flares of the light from the headlights (referred to as a “headlight flare region RG_{fl}”).

The headlight region RG_{HL} is calculated by dividing, for instance, pixel by pixel, a region occupied by the target vehicle that is extracted at the step S105, and by applying necessary processes to each divided region (for example, each pixel). Practically, the illuminance of each divided region is calculated and determined as to whether or not the calculated illuminance is higher than a predetermined threshold, and the divided regions each having the illuminance higher than the predetermined threshold are regarded as a set showing the headlight region RG_{HL}.

The headlight road-reflected region RG_{ref} is detected by processes including determining illuminance and determining the location of a region satisfying the determination of the illuminance. When there are pixels whose illuminance levels are lower than that of the headlights and higher than a predetermined threshold in the acquired image, the pixels are determined as sets of candidate regions for headlight road-reflected regions RG_{ref}. Of these sets of candidate regions, a region which is blow the target vehicle in the image which is extracted at step S105 is finally determined as a headlight road-reflected region RG_{ref}.

Further, the headlight flare region RG_{fl} is attributable to blur of an image which are caused by some factors including the aberration of a lens mounted in the camera 10 and/or the saturation of imaging elements used by the camera 10. This headlight flare region RG_{fl} is detected by determining illuminance of the acquired image and extension of pixels satisfying the illuminance determination. Practically a region of illuminance levels higher than a predetermined threshold but lower than the illuminance of the headlights is determined in the acquired image. If the region is located around the region of the headlights and exceeds beyond the region indicative of the target vehicle in the acquired image, such a region is designated as a headlight flare region RG_{fl}.

The correction region is exemplified in FIG. 3, where the correction region is given as a region including the headlight region RG_{HL}, the headlight road-reflected region RG_{ref}, and the headlight flare region RG_{fl}.

At a succeeding step S115, the image processor 20 calculates the halation-predicted region, which is defined as an area having predetermined illuminance levels in the correction region calculated at step S110, of which detailed explanations can be given as follows with reference to FIGS. 4A and 4B.

In the graph shown in FIG. 4A, the horizontal axis indicates illuminance and the vertical axis indicates frequency. FIG. 4A shows the illuminance and frequency of each of the pixels that compose the correction region (refer to FIG. 3) which resides in the image shown in FIG. 4B of which image itself is the same as that of FIG. 3.

As shown in FIG. 4A, the graph provides two peaks providing higher frequencies. Of these two, peaks, one peak residing in lower illuminance levels shows a spectrum distribution for images of vehicles and pedestrians and is spread over a wide range of illuminance levels. In contrast, the other peak residing in higher illuminance levels shows spectrum distribution of images of the headlight region RG_{HL}, the headlight road-reflected region RG_{ref}, and the headlight flare region RG_{fl}, has a higher peak value, and is spread over a narrow range of illuminance levels.

This graph indicates that, in general, compared to the region showing the headlights and its related regions, regions showing vehicles, pedestrians, and backgrounds provide lower illuminance levels but take a larger area in the acquired image. In contrast, it can be understood that, the headlight region RG_{HL} and its related region provide higher illuminance levels but occupies less area in the acquired image, compared to the regions showing vehicles, pedestrians, and backgrounds.

Hence, the range having the peak having higher illuminance levels, which is enclosed by a square in FIG. 4A, is calculated as a halation-predicted region which will definitely cause halation in images.

In response to this calculation, at a succeeding step S120, the image correction process is performed by the image processor 20 to reduce the illuminance of the halation-predicted region calculated at step S115, by using a predetermined extinction rate (i.e., a predetermined reduction rate of light).

That is, this image correction process is performed by multiplying the respective illuminance levels of the halation-predicted region by the predetermined extinction rate (i.e., the reduction rate of light; for example, 50%). This multiplication makes it possible to shift the whole illumination levels of the halation-predicted region toward lower illumination levels, as shown by a dashed-two dotted line SH.

At a succeeding step S125, the image of the halation-predicted region which has been corrected/shifted at step S120 is synthesized with (superposed on) the image acquired by the camera 10 at the step S100. This will reduce the illuminance of the headlight region RG_{HL}, the headlight road-reflected region RG_{ref}, and the headlight flare region RGₙ, which are predicted as regions causing the halation, resulting in no halation being caused in an image to be displayed.

The resultant image which has been subjected to the image synthesis is outputted to the display unit 30 for display. After this, the processing is made to return to step S100 for repetition at intervals.

Accordingly, in the imaging apparatus 1, the image of a target vehicle is extracted as, a vehicle region RGᵥₑₕ (refer to FIG. 3), from the image of vehicle's forward views acquired by the camera 10, and a correction region is calculated in the vehicle region RGᵥₑₕ and the vicinity thereof. Then, a halation-predicted region which resides in the correction region is processed into a region in which no halation will occur. The processed region is than synthesized with (i.e., superposed on) the image acquired by the camera 10, before data of the synthesized image are outputted for display on the display unit 10.

In the embodiment, the term “the target vehicle and the vicinity thereof” refers to both the vehicle region RGᵥₑₕ occupied by a target vehicle in the image acquired by the camera 10 and a region to be influenced by the headlights located in the vehicle region RGᵥₑₕ. Specifically, the term “the vicinity thereof” includes the headlight road-reflected region RG_{ref} and the headlight flare region RG_{fl} which is a spread of light occurring due to blur resulting from characteristic (such as an aberration) of the camera 10.

Further, the “illuminance to cause halation” mean such illuminance that causes blur in an image acquired by the camera 10, which is due to high illuminance levels of a target vehicle. This illuminance varies depending on an individual characteristic, such as a saturation characteristic, of the camera 10.

According to the imaging apparatus 1, even if the region consisting of the target vehicle and the vicinity thereof in the image acquired by the camera 10 includes a region having high illuminance to cause halation, such as headlights, this region is corrected such that the region will cause no halation or less halation. Hence, the image displayed by the display unit 30 can present an image with no or less halation in the captured target vehicle and its vicinity.

In this way, the halation can be avoided in the region consisting of the target vehicle and its vicinity, so that accuracy for detecting objects, such as pedestrians which may be hidden by halation if the halation happens, can be raised. Hence, the imaging apparatus 1, which is provided with only one camera 10, is still operable in dark environments such as nighttime, and is able to capture high-illuminance objects with no or less halation.

In the present embodiment, using the vehicle region RGᵥₑₕ extracted from the image acquired by the camera 10, the headlight region RG_{HL}, the headlight road-reflected region RG_{ref}, and the headlight flare region RG_{fl} are calculated as a correction region RG_{cor} reliably. That is, it is possible to reliably detect both a high-illuminance portion (headlights) of a target vehicle running at night and regions influenced by the high-illuminance portion. Such regions are mainly composed of the headlight road-reflected region RG_{ref} and the headlight flare region RG_{fl}. The resultant correction region RG_{cor} is still higher in illuminance than the remaining region in the image acquired by the camera 10. In addition, the headlight flare region RG_{fl} is attributable to characteristics of the camera 10 which are influenced largely by the higher illuminance of light. Aberration of the lens employed by the camera 10 is one example of such camera characteristics.

In calculating the halation-predicted region, an image of the region calculated by the correction region calculating process is utilized. That is, in the accumulated image, a region of which illuminance levels fall into a predetermined range is employed as a halation-predicted region. It is sufficient to focus on only the area of the image already calculated by the correction region calculating process. Conversely, it is not needed to search for a halation-predicted region in all the area of the image acquired by the camera 10. Thus load to the calculation of the image processor 20 can be greatly reduced.

Additionally, in the image correction process according to the present embodiment, the correction is very simple, because a predetermined extinction rate is simply applied to the illuminance of each of the pixels that compose halation-predicted region predicted by the halation region calculating process.

In the foregoing embodiment, some other modifications can also be provided. For example, the image processor 20 is provided with the CPU, the ROM, the RAM and the I/O interface, but this is not only one construction; a DSP (digital signal processor) may be placed instead of the CPU. When the DSP is employed, the foregoing various processes including the vehicle extracting process, the correction region calculating process, the halation region calculating process, the image correction process, and the image output process may be performed by different plural DSPs, respectively, or those processes may be combined so that one DSP can perform the combined processes.

For the sake of completeness, it should be mentioned that the various embodiments explained so far are not definitive lists of possible embodiments. The expert will appreciates that it is possible to combine the various construction details or to supplement or modify them by measures known from the prior art without departing from the basic inventive principle.

What is claimed is:

1. An apparatus for processing an image acquired by single image acquisition means mounted in a vehicle, the image acquisition means imaging a field of view on and along a road on which the vehicle runs, the apparatus comprising:
vehicle-region extracting means for extracting from the acquired image a region indicative of a target vehicle captured by the image acquisition means;
correction-region calculating means for calculating a correction region whose illuminance should be corrected, based on an illuminance of the image around the target vehicle in the image, the correction region including both the region indicative of the target vehicle and a vicinity of the region indicative of the target vehicle;
halation-region calculating means for calculating a region of halation being predicted in the calculated correction region, the region of halation being predicted due to having an illuminance at which the halation is caused;
correction means for correcting the illuminance of the region of halation being predicted so that no or less halation is caused in the region of the halation being predicted; and
image output means for outputting an image in which the corrected region of halation whose illuminance is corrected is overlapped on the image acquired by the image acquisition means.

2. The image processing apparatus according to claim 1, wherein the correction region includes a region showing headlights of the target vehicle, a region showing reflection of the headlights of the target vehicle on the road, and a region showing flare of the headlights.

3. The image processing apparatus according to claim 1, wherein the halation-region calculating means is configured to calculate, as the region of halation being predicted, a region having a predetermined range of illuminance in the calculated correction region.

4. The image processing apparatus according to claim 1, wherein the correction means is configured to reduce the illuminance of the region of halation being predicted at a given extinction rate.

5. The image processing apparatus according to claim 2, wherein the halation-region calculating means is configured to calculate, as the region of halation being predicted, a region having a predetermined range of illuminance in the calculated correction region.

6. The image processing apparatus according to claim 5, wherein the correction means is configured to reduce the illuminance of the region of halation being predicted at a given extinction rate.

7. The image processing apparatus according to claim 3, wherein the correction means is configured to reduce the illuminance of the region of halation being predicted at a given extinction rate.

8. A method of processing an image acquired by single image acquisition means mounted in a vehicle, the image acquisition means imaging a field of view on and along a road on which the vehicle runs, the method comprising steps of:
extracting from the acquired image a region indicative of a target vehicle captured by the image acquisition means;
calculating a correction region whose illuminance should be corrected, based on an illuminance of the image around the target vehicle in the image, the correction region including both the region indicative of the target vehicle and a vicinity of the region indicative of the target vehicle;
calculating a region of halation being predicted in the calculated correction region, the region of halation being predicted due to having an illuminance at which the halation is caused;
correction means for correcting the illuminance of the region of halation being predicted so that no or less halation is caused in the region of the halation being predicted; and
image output means for outputting an image in which the corrected region of halation whose illuminance is corrected is overlapped on the image acquired by the image acquisition means.

9. The method according to claim 8, wherein the correction region includes a region showing headlights of the target vehicle, a region showing reflection of the headlights of the target vehicle on the road, and a region showing flare of the headlights.

10. The method according to claim 8, wherein the halation-region calculating step calculates, as the region of halation being predicted, a region having a predetermined range of illuminance in the calculated correction region.

11. The method according to claim 8, wherein the correction step reduces the illuminance of the region of halation being predicted at a given extinction rate.

12. An imaging apparatus to be mounted in a vehicle, comprising:
single image acquisition means to be mounted in the vehicle to image a field of view on and along a road on which the vehicle runs;
vehicle-region extracting means for extracting from the acquired image a region indicative of a target vehicle captured by the image acquisition means;
correction-region calculating means for calculating a correction region whose illuminance should be corrected, based on an illuminance of the image around the target vehicle in the image, the correction region including both the region indicative of the target vehicle and a vicinity of the region indicative of the target vehicle;
halation-region calculating means for calculating a region of halation being predicted in the calculated correction region, the region of halation being predicted due to having an illuminance at which the halation is caused;
correction means for correcting the illuminance of the region of halation being predicted so that no or less halation is caused in the region of the halation being predicted; and
image output means for outputting an image in which the corrected region of halation whose illuminance is corrected is overlapped on the image acquired by the image acquisition means.

13. The imaging apparatus according to claim 12, wherein the correction region includes a region showing headlights of the target vehicle, a region showing reflection of the headlights of the target vehicle on the road, and a region showing flare of the headlights.

14. The imaging apparatus according to claim 12, wherein the halation-region calculating means is configured to calculate, as the region of halation being predicted, a region having a predetermined range of illuminance in the calculated correction region.

15. The imaging apparatus according to claim 12, wherein the correction means is configured to reduce the illuminance of the region of halation being predicted at a given extinction rate.

16. The imaging apparatus according to claim 12, further comprising a display device which the image outputted from the image output means.
